(19) United States
(12) Patent Application Publication
(10) Pub. No.: US 2026/0285356 A1
(43) Pub. Date: Sep. 24, 2026

(54) SYSTEMS AND METHODS OF SCORING CONFIDENCE IN AUTONOMOUS DRIVING OF AUTONOMOUS VEHICLES

(71) Applicant: Torc Robotics, Inc., Blacksburg, VA (US)

(72) Inventors: Christoph Merz, Stuttgart (DE); Nick Schneider, Bruchsal (DE)

(21) Appl. No.: 19/082,441

(22) Filed: Mar. 18, 2025

(51) Int. Cl. B60W 60/00; B60W 50/14; G07C 5/08

(52) U.S. Cl. CPC B60W 60/001; B60W 50/14; G07C 5/0816

(57) ABSTRACT

An autonomy computing system of an autonomous vehicle for scoring a confidence level in autonomous driving by the autonomy computing system is provided. The autonomy computing system includes at least one processor in communication with at least one memory device. The at least one processor is programmed to determine a composite confidence score of autonomous driving by the autonomy computing system of an autonomous vehicle while the autonomous vehicle is operating in an environment. The at least one processor is further programmed to compare the composite confidence score with a threshold, generate an alert based on a comparison indicating a low confidence in the autonomous driving, and control operation of the autonomous vehicle based on the alert and the composite confidence score by alerting a human supervisor of the low confidence.

### TECHNICAL FIELD

The field of the disclosure relates generally to autonomous vehicles and, more specifically, to systems and methods in scoring confidence of autonomous driving.

### BACKGROUND OF THE INVENTION

An autonomous vehicle relies on its autonomy computing system to perceive the environment in which the autonomous vehicle is operating or traveling, and plan and control the operation of the autonomous vehicle in the environment. As development of autonomous driving approaches driverless, an autonomous vehicle may drive under autonomous driving for a relatively long stretch of time or distance without mishap. Accordingly, it is desirable to provide systems and methods for improved alerting system for human supervisor drivers in developing and/or deployment of autonomous vehicles.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomy computing system of an autonomous vehicle for scoring a confidence level in autonomous driving by the autonomy computing system is provided. The autonomy computing system includes at least one processor in communication with at least one memory device. The at least one processor is programmed to determine a composite confidence score of autonomous driving by the autonomy computing system of an autonomous vehicle while the autonomous vehicle is operating in an environment. The at least one processor is further programmed to compare the composite confidence score with a threshold, generate an alert based on a comparison indicating a low confidence in the autonomous driving, and control operation of the autonomous vehicle based on the alert and the composite confidence score by alerting a human supervisor of the low confidence.

In another aspect, one or more non-transitory machine-readable storage media for scoring a confidence level in autonomous driving by an autonomy computing system of an autonomous vehicle is provided. The one or more non-transitory machine-readable storage media include a plurality of instructions stored thereon that, in response to being executed, cause a system to determine a composite confidence score of autonomous driving by an autonomy computing system of an autonomous vehicle while the autonomous vehicle is operating in an environment. The plurality of instructions further cause the system to compare the composite confidence score with a threshold, generate an alert based on a comparison indicating a low confidence in the autonomous driving, and control operation of the autonomous vehicle based on the alert and the composite confidence score by alerting a human supervisor of the low confidence.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle.

FIG. 2 is a block diagram of an autonomous vehicle.

FIG. 3A is a flow chart of an example method of operating the autonomy vehicle shown in FIGS. 1 and 2.

FIG. 3B is a flow chart of determining a composite confidence score in the method shown in FIG. 3A.

FIG. 4A is a schematic diagram of a neural network model.

FIG. 4B is a schematic diagram of a neuron in the neural network model shown in FIG. 4A.

FIG. 5 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

Systems and methods for autonomous driving are provided. An autonomy computing system of an autonomous vehicle perceives the environment in which the autonomous vehicle operates and controls operation of the autonomous vehicle in the environment. During development and deployment of an autonomous vehicle, human supervision and intervention may be needed because autonomous driving may not have encountered all scenarios in real-world driving. To increase the safety in autonomous driving, the areas of unknown, hazardous scenarios need to be reduced. An alert may be provided to the human driver to ensure the human driver is aware of the current surroundings and situations. Generating an alert based on an indicator of the confidence level in autonomous driving when needed, however, is difficult because autonomous driving involves various aspects of operation of the autonomous vehicle and myriads of inputs and outputs during various stages and in various modules, and distilling confidence in autonomous driving into one single indicator requires understanding of the complicated system and pinpointing factors and weights for indicating the confidence.

Systems and methods described herein address the above-described problems by providing a composite confidence score that indicates the level of confidence in autonomous driving by the autonomy computing system. The composite confidence score includes various aspects of autonomous driving, including an understanding confidence score indicating the confidence score in understanding the environment and the state of the ego, a behavior confidence score in planning a trajectory, and an acting confidence score in controlling the autonomous vehicle to travel along the trajectory. Anomalies in inputs to and outputs from machine learning models in the autonomy computing system are also detected and the detected anomalies are provided to the understanding confidence score, the behavior confidence score, and/or the acting confidence score. Accordingly, the composite confidence score reflects the confidence level of the autonomy computing system in handling various aspects of autonomous driving. The composite confidence score is used to alert a human supervisor, thereby reducing reaction time from the human supervisor and increasing safety of the autonomous vehicle. A human supervisor may be a human driver of the autonomous vehicle, an in-vehicle fallback driver, or a remote assistant who remotely monitors one or more autonomous vehicles.

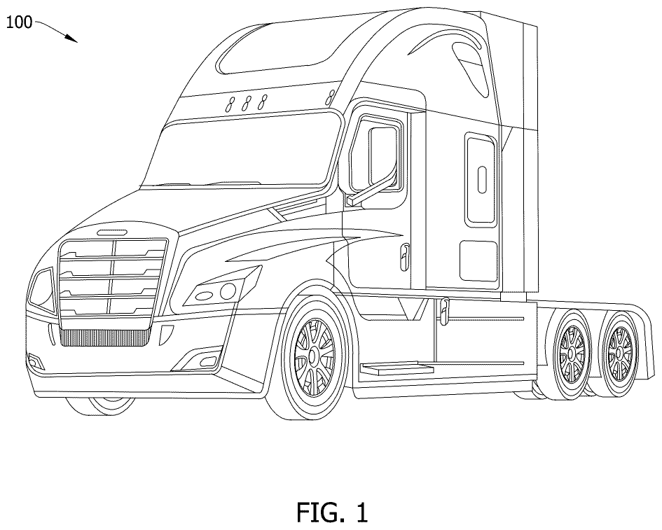

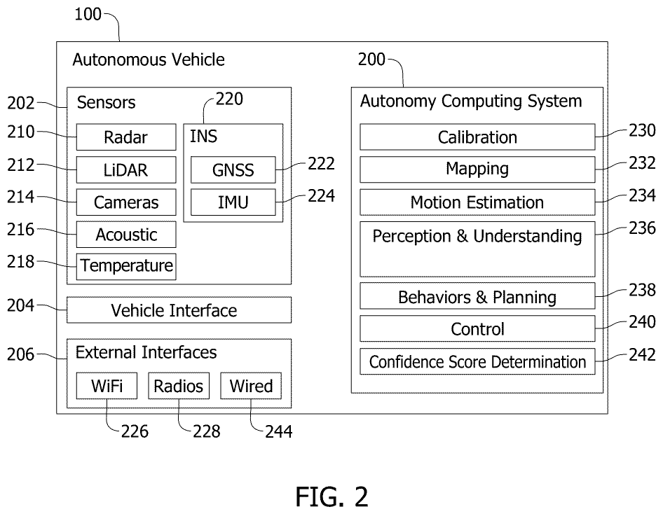

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (radar) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operation of autonomous vehicle 100.

Cameras 214 may include RGB cameras, which are configured to capture images based on visible light. Cameras 214 may further include a gated camera, such as gated near infrared (NIR) camera. A gated camera is configured to capture images based on invisible light, such as NIR light. Cameras 214 are configured to capture images of the environment surrounding autonomous vehicle 100 in any aspect or field of view (FOV). The FOV can have any angle or aspect such that images of the areas in front of, to the side of, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras'FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas in front of, to the side of, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a confidence score determination module 242. Confidence score determination module 242 may be include in another module or separate from other modules. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous), semi-autonomous, or with any level of autonomy. In one example, autonomy computing system 200 can operate under Level 5 autonomy (e.g., full driving automation), Level 4 autonomy (e.g., high driving automation), Level 3 autonomy (e.g., conditional driving automation), Level 2 autonomy (e.g., partial driving automation), or Level 1 autonomy (e.g., driver assistance). As used herein the term “autonomous” includes fully autonomous, semi-autonomous, or having any level of autonomy.

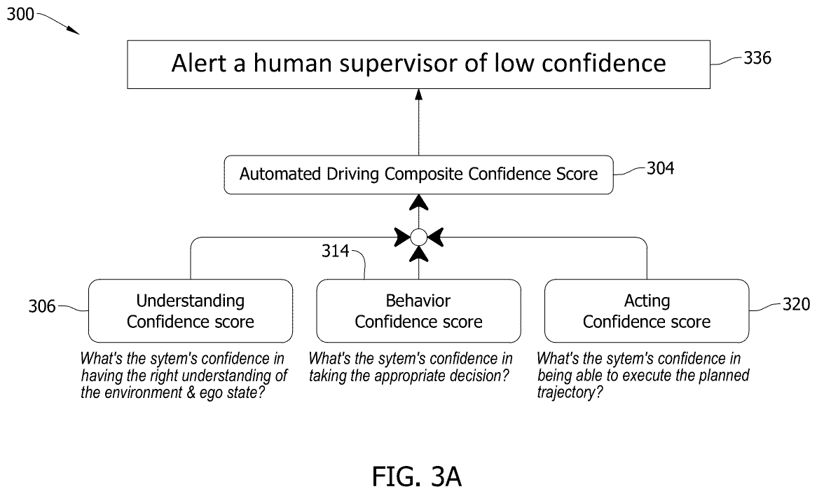

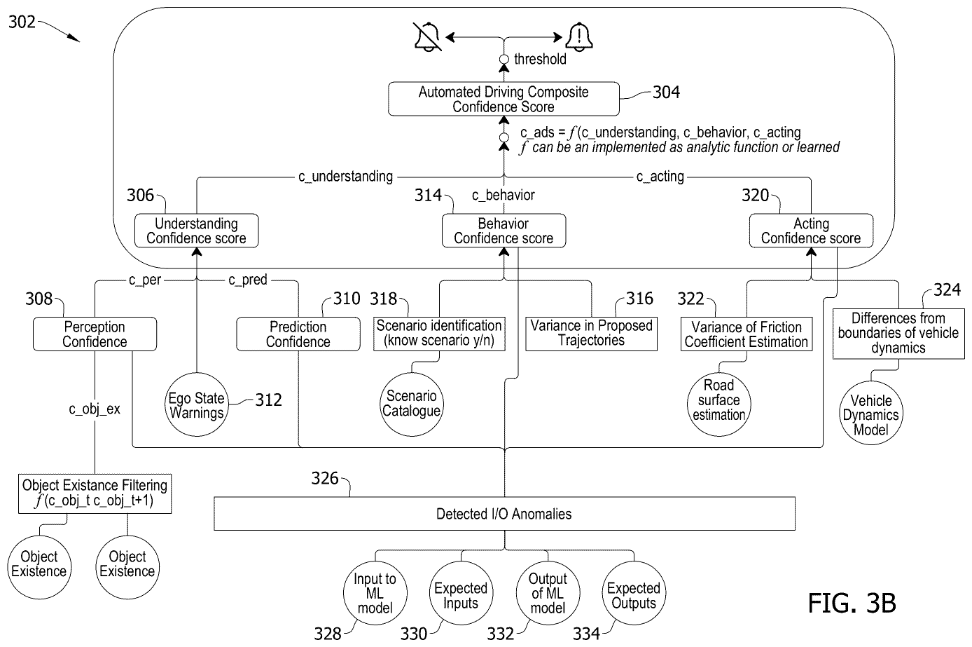

FIGS. 3A and 3B show example method 300 of operating autonomous vehicle 100 by autonomy computing system 200. Method 300 may be implemented in confidence score determination module 242. FIG. 3A is a flow chart of method 300. FIG. 3B is a flow chart of determining 302 a composite score of autonomous driving by autonomy computing system 200. In the example embodiment, method 300 includes determining 302 a composite score of autonomous driving by autonomy computing system 200 while autonomous vehicle 100 is operating in an environment. When driving in an environment, autonomy computing system 200 controls operation of autonomous vehicle in three major processes of perceiving, planning, and acting. Autonomy computing system 200, via perception and understanding module 236 (see FIG. 2), first perceives the environment, such as objects like actors or roads in the environment, and predicts the motion of the actors. Actors include vehicles, cyclists, or pedestrians. Based on the perceptions and predictions, in the process of planning, autonomy computing system 200 identifies the driving scenario that autonomous vehicle 100 is experiencing and plans the behavior of autonomous vehicle 100, such as providing candidate trajectories. In the process of acting, autonomy computing system 200, via control module 240, control operation of autonomous vehicle 100 to travel along a planned trajectory output from behaviors and planning module 238. During acting, autonomy computing system 200 determines the capability of autonomous vehicle 100 to operate according to the planned trajectory. Autonomy computing system 200 may determine whether the required nonlinear vehicle parameters by the planned trajectory are comfortably within the boundaries of vehicle dynamics of autonomous vehicle 100. For example, acceleration, turning angles, and jerk are nonlinear vehicle parameters. Boundaries of vehicle dynamics are minima and maxima of those parameters. Autonomy computing system 200 determines whether autonomous vehicle 100 is capable to operate at the required parameters, under the constraints from the boundaries of vehicle dynamics. Autonomy computing system 200 also determines the road conditions, such as friction coefficient estimation because the friction coefficient of the road also affect the capability of autonomous vehicle 100 to travel along the planned trajectory.

In the example embodiment, composite confidence score 304 indicates the confidence level of autonomy computing system 200 in perceiving, planning, and acting. Composite confidence score 304 includes an understanding confidence score 306 indicating the confidence level of autonomy computing system 200 in perceiving the environment and the states of ego. Ego refers to the autonomous vehicle itself. Autonomy computing system 200 includes one or more machine learning models. For example, perception and understanding module 236 may include one or more machine learning models configured to perform the functions of perception and understanding module 236, such as perceiving objects in the environment and predicting the motion of the objects. Understanding confidence score 306 may be determined based on a confidence level 308 of perception of objects in the environment and/or a confidence level 310 of prediction of motion of the objects. When the machine learning models of perception and understanding module 236 provides a relatively high confidence level in its functions, understanding confidence score 306 is relatively high, and vice versa. Another example factor that affects understanding confidence score 306 is visibility and/or changes in the visibility of the environment. Visibility may be represented as distance of an object in the environment being visible and/or scatter of point clouds, such as LiDAR and/or radar point clouds. If the visibility is relatively clear where the visibility is at or above a threshold, or the visibility is relatively stable where the change in the visibility is at or below a threshold, understanding confidence score 306 is relatively high. If the visibility is relatively low such as at or below the threshold, and the visibility change is relatively high or is at or above the threshold, understanding confidence score 306 is relatively low. Ego state warnings 312 may also affect understanding confidence score 306. For example, if no internal warnings of autonomous vehicle 100 are present, understanding confidence score 306 is relatively high. If one or more internal warnings, such as sensor malfunction, understanding confidence score 306 is relatively low. Thresholds may be pre-defined, user-defined, or learned via a machine learning model. In one example, understanding confidence score 306 includes a weighted sum of the confidence level 308 of perceptions, the confidence level 310 of predictions, visibility, and/or ego state warnings 312. The weights may be pre-defined, user defined, or learned via a machine learning model.

In the example embodiments, composite confidence score 304 further includes a behavior confidence score 314. Behavior confidence score 314 indicates the confidence level that autonomy computing system 200, such as behaviors and planning module 238, has in planning the trajectory of autonomous vehicle 100. Behavior confidence score 314 may be determined based on variance 316 in proposed trajectories by behaviors and planning module 238. If the difference or variance between confidence scores of the primary trajectory and the second trajectory is relatively high, such as at or above a threshold, behavior confidence score 314 is relatively high. Alternatively or additionally, if the primary trajectory and the secondary trajectory are similar to one another, such as the differences of parameters of the primary trajectory and the secondary trajectory being at or below thresholds, behavior confidence score 314 is relatively high. A relatively high behavior confidence score 314 indicates the choice of the trajectory output from behaviors and planning module 238 is readily available. If bifurcated trajectories are presented, where the primary and secondary trajectories are significantly different from one another, such as differences in parameters of the primary and secondary trajectories being at or above thresholds while the difference between the confidence scores of the primary trajectory and the secondary trajectory are relatively small, such as being at or below a threshold, behavior confidence score 314 is relatively low.

In the example embodiment, additionally or alternatively, behavior confidence score 314 may be determined based on a confidence level 318 in scenario identification. Behaviors and planning module 238 is also configured to identify the driving scenario in which autonomous vehicle 100 is operating, such as a cut-in scenario or an overtaking scenario. If the confidence level of behaviors and planning module 238 in identifying the scenario is relatively high, such as at or above a threshold, behavior confidence score 314 is relatively high.

In the example embodiments, the various thresholds may be pre-defined, user defined, or learned via a machine learning model. In one example, understanding confidence score 306 includes a weighted sum of confidence levels in proposed trajectories and scenario identification. The weights may be pre-defined, user-defined, or learned via a machine learning model.

In the example embodiments, composite confidence score 304 further includes an acting confidence score 320 indicating the confidence level of autonomy computing system 200, such as control module 240, in controlling the operation of autonomous vehicle 100 to travel along the trajectory output from behaviors and planning module 238. Factors affecting acting confidence score 320 includes variance 322 of friction coefficient estimation of the road and differences 324 from boundaries of vehicle dynamics. For example, if the road surface is regular such as the road being dry or wet, where variance 322 of friction coefficient estimation is relatively small, such as at or below a threshold, acting confidence score 320 is relatively high. If the road friction is unclear or uncertain, such as the road surface having ice or oil, or being at least partially flooded, where variance 322 of estimation of road friction is relatively high, such as being at or above the threshold, acting confidence score 320 is relatively low.

In the example embodiments, differences from boundaries of vehicle dynamics may also affect acting confidence score 320. Boundaries of vehicle dynamics include the maximal and minimal acceleration and/or deceleration, turning angles, and jerk. If parameters required by the planned trajectory output from behaviors and planning module 238 are well within the boundaries, where the parameters are within the boundaries and the differences between the parameters and the boundaries are at or above one or more thresholds, acting confidence score 320 is relatively high. If the differences between the parameters and the boundaries are small, such as being at or below the one or more thresholds, or the parameters exceed one or more boundaries of vehicle dynamics, acting confidence score 320 is relatively low. The thresholds may be pre-defined, user-defined, or learned via a machine learning model. In one example, acting confidence score 320 is a weighted sum of variance 322 of friction coefficient estimation and differences 324 from boundaries of vehicle dynamics. Weights may be predefined, user-defined, or learned via a machine learning model.

In the example embodiment, understanding confidence score 306, behavior confidence score 314, and/or acting confidence score 320 are affected by detected anomalies 326 in inputs or outputs of machine learning models in autonomy computing system 200, such as in perception and understanding module 236, behaviors and planning module 238, or control module 240. The inputs 328 to the machine learning models are compared with expected inputs 330 to the machine learning models. If inputs 328 are within the ranges of expected inputs 330, an input anomaly is not detected. If inputs 328 are outside one or more ranges of expected inputs 330, an input anomaly is detected. Outputs 332 from machine learning models are compared with expected outputs 334 from the machine learning models. If outputs 332 are within ranges of expected outputs 334, an output anomaly is not detected. If outputs 332 are outside one or more ranges of expected outputs 334, an output anomaly is detected. Detected anomalies 326 are input into determination of understanding confidence score 306, behavior confidence score 314, and acting confidence score 320, and reduces these confidence scores 306, 314, 320. The confidence scores 306, 314, 320 may be a weighted sum of factors, including a weighted addition from detected anomalies. The weights form detected anomalies may be predefined, user-defined, or learned via a machine learning model.

In the example embodiment, composite confidence score 304 is a function of understanding confidence score 306, behavior confidence score 314, and acting confidence score 320. The function may be an analytical function, such as a weighted sum of confidence scores 306, 314, 320. The weights may be predefined, user-defined, or learned via a machine learning mode. Alternatively, the function is learned via a machine learning model.

In the example embodiment, composite confidence score 304 is compared with a threshold. The threshold may be predefined, user-defined, or learned via a machine learning model.

In the example embodiment, autonomy computing system 200 is configured to control operation of autonomous vehicle 100 based on the comparison, such as providing an alert to a human supervisor of the autonomous vehicle to be prepared to take over control of autonomous vehicle 100 if the comparison result indicates low confidence. For example, if composite confidence score 304 is below or at the threshold, an alert is triggered 336, indicating autonomy computing system 200 is not confident in the autonomous driving of autonomous vehicle 100.

In one example, in deployment of level 2 autonomous driving, particularly for hands-free autonomous driving, the alert alerts the driver to be prepared to move hands back to the steering wheel to reduce reaction time for a potential take-over of the driving. Providing alerts when composite confidence score 304 is low is advantageous in reducing the reaction time, thereby increasing safety of driving.

In another example, in deployment of level 3 autonomous driving, which requires a human driver to take over within a specific time period set by the manufacturer of autonomous vehicle 100 before triggering one or more minimal risk maneuver (MRM). MRMs are maneuvers or actions by the autonomous vehicle to reduce risks to the autonomous vehicle, other vehicles, people, animals, or structures on the road when the autonomous vehicle experiences a component failure. Alerting the human driver when composite confidence score 304 is relatively low is advantageous in extending the time for the human driver to understand the current driving context and reduce false triggering of an MRM due to the human driver's failure to respond to a take-over request in time, thereby reducing potential risks and/or damage associate with the MRM.

In one more example, during development of level 4 autonomous driving, an in-vehicle fallback test driver (IFTD) is present in the cabin of autonomous vehicle and takes over the driving when needed to ensure the safety of autonomous vehicle. At level 4, autonomous driving is close to driverless, where autonomous vehicle 100 may drive several hundred miles or kilometers in a stretch without a mishap. After such a long stretch, the attention span of the IFTD is fatigued. Alerting the IFTD to be prepared to take over when composite confidence score 304 is relatively low is advantageous in alerting the IFTD to be prepared to take over and reducing the reaction time. During the deployment of level 4 autonomous driving, the alert may be provided to a remote assistant. A remote assistant may be responsible for multiple autonomous vehicles. When the remote assistant receives an alert when composite confidence score 304 for an alerting autonomous vehicle 100 is relatively low, autonomy computing system 200 of alerting autonomous vehicle 100 may initiate a remote assistance call and provide the remote assistant time to familiarize with the context in which alerting autonomous vehicle 100 is driving and provide assistance accordingly. For example, video streams may be shared with the remote assistant such that the remote assistant may understand the situation and help to clarify ambiguous situations.

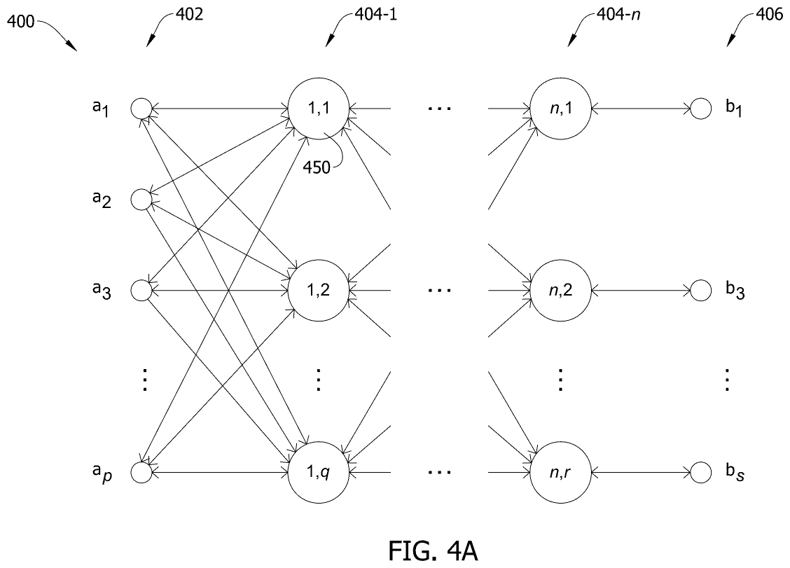

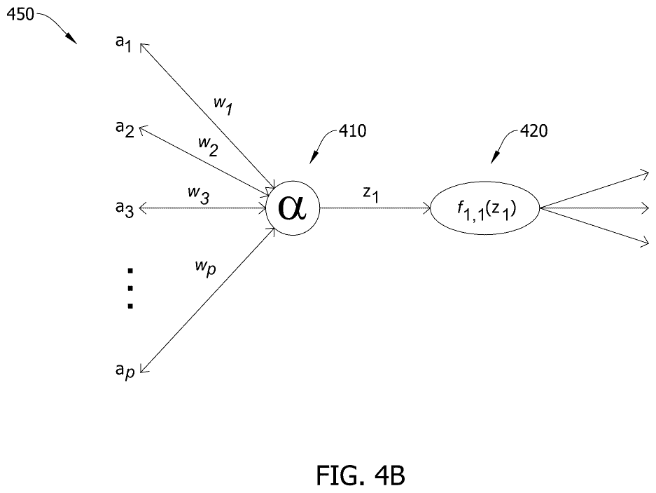

FIG. 4A depicts an example artificial neural network model 400. Systems and methods described herein may be implemented with one or more neural network models 400. The example neural network model 400 includes layers of neurons 450, 404-1 to 404-n, and 406, including an input layer 402, one or more hidden layers 404-1 through 404-n, and an output layer 406. Each layer may include any number of neurons, i.e., q, r, and n in FIG. 4A may be any positive integer. It should be understood that neural networks of a different structure and configuration from that depicted in FIG. 4A may be used to achieve the methods and systems described herein.

In the example embodiment, the input layer 402 may receive different input data. For example, the input layer 402 includes a first input a₁ representing training images, a second input a₂ representing patterns identified in the training images, a third input a₃ representing edges of the training images, and so on. The input layer 402 may include thousands or more inputs. In some embodiments, the number of elements used by the neural network model 400 changes during the training process, and some neurons are bypassed or ignored if, for example, during execution of the neural network, they are determined to be of less relevance.

In the example embodiment, each neuron in hidden layer(s) 404-1 through 404-n processes one or more inputs from the input layer 402, and/or one or more outputs from neurons in one of the previous hidden layers, to generate a decision or output. The output layer 406 includes one or more outputs each indicating a label, confidence factor, weight describing the inputs, and/or an output image. In some embodiments, however, outputs of the neural network model 400 are obtained from a hidden layer 404-1 through 404-n in addition to, or in place of, output(s) from the output layer(s) 406.

In some embodiments, each layer has a discrete, recognizable function with respect to input data. For example, if n is equal to 3, a first layer analyzes the first dimension of the inputs, a second layer analyzes the second dimension, and the final layer analyzes the third dimension of the inputs. Dimensions may correspond to aspects considered strongly determinative, then those considered of intermediate importance, and finally those of less relevance.

In other embodiments, the layers are not clearly delineated in terms of the functionality they perform. For example, two or more of hidden layers 404-1 through 404-n may share decisions relating to labeling, with no single layer making an independent decision as to labeling.

FIG. 4B depicts an example neuron 450 that corresponds to the neuron labeled as “1,1” in hidden layer 404-1 of FIG. 4A, according to one embodiment. Each of the inputs to the neuron 450 (e.g., the inputs in the input layer 402 in FIG. 4A) is weighted such that input a₁ through aₚ corresponds to weights w₁ through wₚ as determined during the training process of the neural network model 400.

In some embodiments, some inputs lack an explicit weight, or have a weight below a threshold. The weights are applied to a function α (labeled by a reference numeral 410), which may be a summation and may produce a value z₁ which is input to a function 420, labeled as f_{1,1}(z₁). The function 420 is any suitable linear or non-linear function. As depicted in FIG. 4B, the function 420 produces multiple outputs, which may be provided to neuron(s) of a subsequent layer, or used as an output of the neural network model 400. For example, the outputs may correspond to index values of a list of labels, or may be calculated values used as inputs to subsequent functions.

It should be appreciated that the structure and function of the neural network model 400 and the neuron 450 depicted are for illustration purposes only, and that other suitable configurations exist. For example, the output of any given neuron may depend not only on values determined by past neurons, but also on future neurons.

The neural network model 400 may include a convolutional neural network (CNN), a deep learning neural network, a reinforced or reinforcement learning module or program, or a combined learning module or program that learns in two or more fields or areas of interest. Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. The neural network model 400 may be trained using unsupervised machine learning programs. In unsupervised machine learning, the processing element may be required to find its own structure in unlabeled example inputs. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as images, object statistics, and information. The machine learning programs may use deep learning algorithms that may be primarily focused on pattern recognition, and may be trained after processing multiple examples. The machine learning programs may include Bayesian Program Learning (BPL), voice recognition and synthesis, image or object recognition, optical character recognition, and/or natural language processing-either individually or in combination. The machine learning programs may also include natural language processing, semantic analysis, automatic reasoning, and/or machine learning.

Based upon these analyses, the neural network model 400 may learn how to identify characteristics and patterns that may then be applied to analyzing image data, model data, and/or other data. For example, the model 400 may learn to identify features in a series of data points.

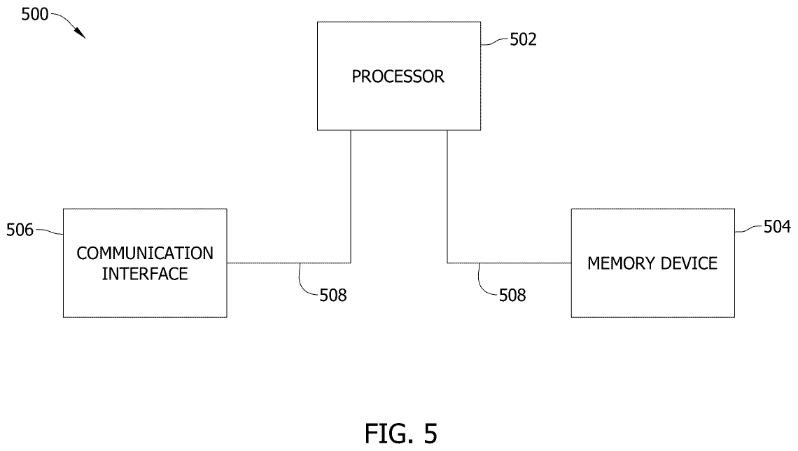

FIG. 5 is a block diagram of an example computing device 500. Autonomy computing system 200 may be implemented with one or more computing devices 500. In the example embodiment, computing device 500 includes a processor 502 and a memory device 504. The processor 502 is coupled to the memory device 504 via a system bus 508. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 504 includes one or more devices that enable information, such as executable instructions or other data (e.g., sensor data), to be stored and retrieved. Moreover, the memory device 504 includes one or more computer readable media, such as, without limitation, dynamic random access memory (DRAM), static random access memory (SRAM), a solid state disk, or a hard disk. In the example embodiment, the memory device 504 stores, without limitation, application source code, application object code, configuration data, additional input events, application states, assertion statements, validation results, or any other type of data. The computing device 500, in the example embodiment, may also include a communication interface 506 that is coupled to the processor 502 via system bus 508. Moreover, the communication interface 506 is communicatively coupled to data acquisition devices.

In the example embodiment, processor 502 may be programmed by encoding an operation using one or more executable instructions and providing the executable instructions in the memory device 504. In the example embodiment, the processor 502 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

### MACHINE LEARNING & OTHER MATTERS

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample (e.g., training) data sets or certain data into the programs, such as conversation data of spoken conversations to be analyzed, mobile device data, and/or additional speech data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or other types of machine learning, such as deep learning, reinforced learning, or combined learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed. In one embodiment, machine learning techniques may be used to extract data about the conversation, statement, utterance, spoken word, typed word, geolocation data, and/or other data.

An example technical effect of the methods, systems, and apparatus described herein includes at least one of: (a) generating one single composite confidence score to indicate confidence in autonomous driving, (b) generating a composite score including an understanding confidence score, a behavior confidence score, and/or an acting confidence score, (c) generating an understanding confidence score, a behavior confidence score, and/or an acting confidence score based on detected anomalies in inputs to and/or outputs from one or more machine learning models of the autonomy computing system, or (d) alerting a human supervisor during development and/or deployment of the autonomous vehicle when the confidence of autonomous driving is low as indicated by the composite confidence score.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable/machine-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An autonomy computing system of an autonomous vehicle for scoring a confidence level in autonomous driving by the autonomy computing system, comprising at least one processor in communication with at least one memory device, the at least one processor programmed to:
determine a composite confidence score of autonomous driving by the autonomy computing system of an autonomous vehicle while the autonomous vehicle is operating in an environment;
compare the composite confidence score with a threshold;
generate an alert based on a comparison indicating a low confidence in the autonomous driving; and
control operation of the autonomous vehicle based on the alert and the composite confidence score by alerting a human supervisor of the low confidence.

2. The autonomy computing system of claim 1, wherein the at least one processor is further programmed to:
determine the composite confidence score including an understanding confidence score.

3. The autonomy computing system of claim 2, wherein the at least one processor is further programmed to:
determine the understanding confidence score based on at least one of i) a confidence score of perception of objects in the environment by the autonomy computing system, ii) a confidence score of prediction of motion of the objects by the autonomy computing system, iii) visibility of the environment, or iv) ego state warnings.

4. The autonomy computing system of claim 1, wherein the at least one processor is further programmed to:
determine the composite confidence score including a behavior confidence score.

5. The autonomy computing system of claim 4, wherein the at least one processor is further programmed to:
determine the behavior confidence score based on at least one of i) variance in proposed trajectories by the autonomy computing system or ii) a confidence level in scenario identification by the autonomy computing system.

6. The autonomy computing system of claim 1, wherein the at least one processor is further programmed to:
determine the composite confidence score including an acting confidence score.

7. The autonomy computing system of claim 6, wherein the at least one processor is further programmed to:
determine the acting confidence score based on at least one of i) variance of friction coefficient estimation of a road along which the autonomous vehicle is traveling or ii) differences of parameters in a trajectory planned by the autonomy computing system from boundaries of vehicle dynamics of the autonomous vehicle.

8. The autonomy computing system of claim 1, wherein the at least one processor is further programmed to:
determine the composite confidence score as a function of an understanding confidence score, a behavior confidence score, and an acting confidence score.

9. The autonomy computing system of claim 8, wherein the at least one processor is further programmed to:
determine at least one of the understanding confidence score, the behavior confidence score, or the acting confidence score based on detected anomalies in inputs to and/or outputs from one or more machine learning models of the autonomy computing system.

10. The autonomy computing system of claim 1, wherein the at least one processor is further programmed to:
initiate one or more actions including at least one of i) alerting the human supervisor to be prepared to take over control of the autonomous vehicle during deployment of the autonomous vehicle, ii) alerting the human supervisor to be prepared to take over during development of the autonomous vehicle, or iii) alerting a remote assistant to monitor the autonomous vehicle.

11. One or more non-transitory machine-readable storage media for scoring a confidence level in autonomous driving by an autonomy computing system of an autonomous vehicle, the one or more non-transitory machine-readable storage media comprising a plurality of instructions stored thereon that, in response to being executed, cause a system to:
determine a composite confidence score of autonomous driving by an autonomy computing system of an autonomous vehicle while the autonomous vehicle is operating in an environment;
compare the composite confidence score with a threshold;
generate an alert based on a comparison indicating a low confidence in the autonomous driving; and
control operation of the autonomous vehicle based on the alert and the composite confidence score by alerting a human supervisor of the low confidence.

12. The one or more non-transitory machine-readable storage media of claim 11, wherein the plurality of instructions further cause the system to:
determine the composite confidence score including an understanding confidence score.

13. The one or more non-transitory machine-readable storage media of claim 12, wherein the plurality of instructions further cause the system to:
determine the understanding confidence score based on at least one of i) a confidence score of perception of objects in the environment by the autonomy computing system, ii) a confidence score of prediction of motion of the objects by the autonomy computing system, iii) visibility of the environment, or iv) ego state warnings.

14. The one or more non-transitory machine-readable storage media of claim 11, wherein the plurality of instructions further cause the system to:
determine the composite confidence score including a behavior confidence score.

15. The one or more non-transitory machine-readable storage media of claim 14, wherein the plurality of instructions further cause the system to:
determine the behavior confidence score based on at least one of i) variance in proposed trajectories by the autonomy computing system or ii) a confidence level in scenario identification by the autonomy computing system.

16. The one or more non-transitory machine-readable storage media of claim 11, wherein the plurality of instructions further cause the system to:
determine the composite confidence score including an acting confidence score.

17. The one or more non-transitory machine-readable storage media of claim 16, wherein the plurality of instructions further cause the system to:
determine the acting confidence score based on at least one of i) variance of friction coefficient estimation of a road along which the autonomous vehicle is traveling or ii) differences of parameters in a trajectory planned by the autonomy computing system from boundaries of vehicle dynamics of the autonomous vehicle.

18. The one or more non-transitory machine-readable storage media of claim 11, wherein the plurality of instructions further cause the system to:
determine the composite confidence score as a function of an understanding confidence score, a behavior confidence score, and an acting confidence score.

19. The one or more non-transitory machine-readable storage media of claim 18, wherein the plurality of instructions further cause the system to:
determine at least one of the understanding confidence score, the behavior confidence score, or the acting confidence score based on detected anomalies in inputs to and/or outputs from one or more machine learning models of the autonomy computing system.

20. The one or more non-transitory machine-readable storage media of claim 11, wherein the plurality of instructions further cause the system to:
initiate one or more actions including at least one of i) alerting the human supervisor to be prepared to take over control of the autonomous vehicle during deployment of the autonomous vehicle, ii) alerting the human supervisor to be prepared to take over during development of the autonomous vehicle, or iii) alerting a remote assistant to monitor the autonomous vehicle.
